(19) United States
(12) Patent Application Publication
(10) Pub. No.: US 2025/0291285 A1
(43) Pub. Date: Sep. 18, 2025

(54) IMAGE FORMING APPARATUS

(71) Applicant: CANON KABUSHIKI KAISHA, Tokyo (JP)

(72) Inventors: HIDEKI OHTA, Shizuoka (JP); TOMOOKU KOYAMA, Shizuoka (JP)

(21) Appl. No.: 19/072,129

(22) Filed: Mar. 6, 2025

(30) Foreign Application Priority Data
Mar. 13, 2024 (JP) 2024-039388

(51) Int. Cl. G03G 15/20; G03G 15/00; G03G 21/16; G03G 21/20

(52) U.S. Cl. CPC G03G 15/2035; G03G 15/2028; G03G 15/2064; G03G 15/657; G03G 21/1633; G03G 21/1685; G03G 21/206; G03G 2215/00413; G03G 2221/1639; G03G 2221/1642

(57) ABSTRACT

An image forming apparatus includes an apparatus body provided with an opening portion, an opening/closing member, a fixing unit, and a moving unit provided in the apparatus body and configured to move the fixing unit from a first position toward a second position above the first position. Movement of the fixing unit from the first position to the second position is restricted in a state in which the opening/closing member is positioned at the closed position and is allowed in a state in which the opening/closing member is positioned at the open position. The moving unit includes a support portion configured to support the fixing unit positioned at the second position such that the fixing unit is attachable and detachable. The support portion extends in a longitudinal direction of the fixing unit and supports the fixing unit from below.

### BACKGROUND OF THE INVENTION

### Field of the Invention

The present invention relates to an image forming apparatus that forms a toner image on a sheet.

### Description of the Related Art

In Japanese Patent Application Laid-Open No. 2010-244018, an image forming apparatus including a door that is openable and closable and a tray for drawing out a cartridge to the outside in a state in which the door is open is proposed. The cartridge is configured to be attachable to and detachable from the tray in a state in which the tray has been drawn out.

In addition, in Japanese Patent Application Laid-Open No. 2012-047806, an image forming apparatus including a pair of arm members provided to be pivotable with respect to an apparatus body, and a fixing unit held at a distal end portion of the arm members is proposed. The fixing unit is configured to be movable between an internal attached position and a temporary holding position closer to an opening portion of the apparatus body than the internal attached position by pivoting the pair of arm members.

In recent years, an image forming apparatus in which a fixing unit can be easily attached to and detached from an apparatus body for replacement or maintenance of the fixing unit has been desired.

### SUMMARY OF THE INVENTION

According to one aspect of the present invention, an image forming apparatus configured to form a toner image on a sheet, the image forming apparatus includes an apparatus body provided with an opening portion, an opening/closing member supported to be openable and closable between an open position and a closed position with respect to the apparatus body, the opening/closing member covering the opening portion at the closed position and opening the opening portion at the open position, a fixing unit supported to be attachable to and detachable from the apparatus body via the opening portion and configured to apply heat and pressure to the sheet to fix the toner image to the sheet, and a moving unit provided in the apparatus body and configured to move the fixing unit from a first position toward a second position above the first position. Movement of the fixing unit from the first position to the second position is restricted in a state in which the opening/closing member is positioned at the closed position and is allowed in a state in which the opening/closing member is positioned at the open position. The moving unit includes a support portion configured to support the fixing unit positioned at the second position such that the fixing unit is attachable and detachable. The support portion extends in a longitudinal direction of the fixing unit and supports the fixing unit from below.

Further features of the present invention will become apparent from the following description of exemplary embodiments with reference to the attached drawings.

### BRIEF DESCRIPTION OF THE DRAWINGS

FIG. 1 is a perspective view of an image forming apparatus according to a first embodiment.

FIG. 2 is a section view illustrating the image forming apparatus.

FIG. 3 is a perspective view of a moving unit.

FIG. 4 is a perspective view of a lower surface of a fixing unit.

FIG. 5 is a perspective view of the image forming apparatus in a state in which a door is open.

FIG. 6 is a perspective view of a fixing lock and a locked portion.

FIG. 7 is a section view of the image forming apparatus in the state in which the door is open.

FIG. 8 is a perspective view illustrating the fixing unit positioned at a second position.

FIG. 9 is a perspective view illustrating a state in which the fixing unit has been detached from a support portion.

FIG. 10 is a perspective view of a moving unit according to a second embodiment.

FIG. 11 is a perspective view of the support portion in a state in which the fixing unit is attached.

FIG. 12 is another perspective view of the support portion in the state in which the fixing unit is attached.

### DESCRIPTION OF THE EMBODIMENTS

### First Embodiment

### Overall Configuration

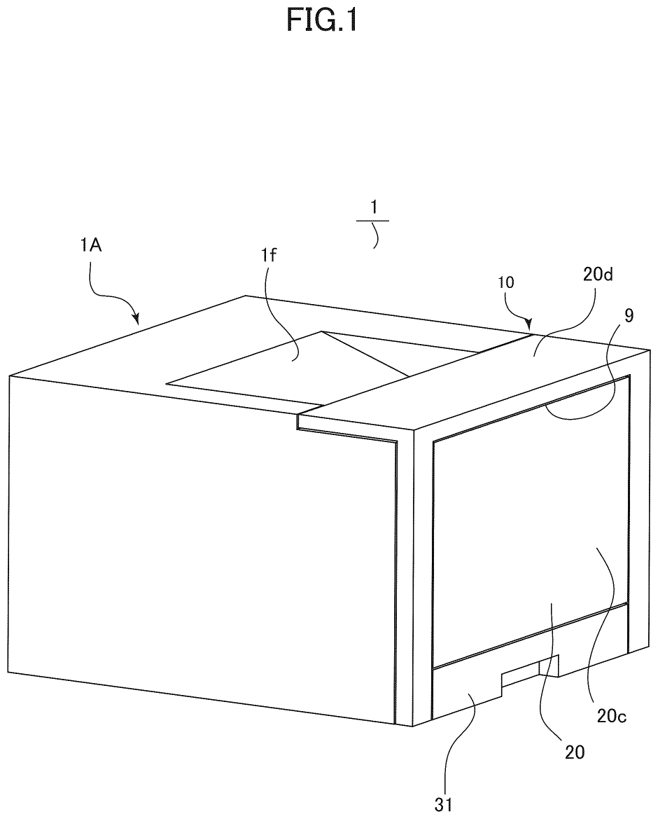

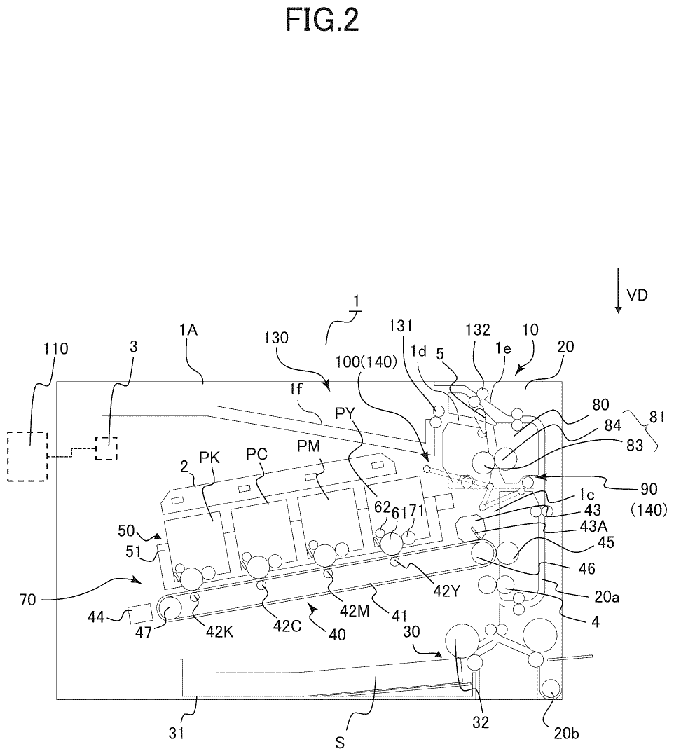

First, a first embodiment of the present disclosure will be described. An image forming apparatus 1 according to a first embodiment is a full-color laser beam printer of an electrophotographic system. FIG. 1 is a perspective view of the image forming apparatus 1. FIG. 2 is a section view of the image forming apparatus 1.

To be noted, examples of the image forming apparatus include printers, copiers, facsimile machines, and multifunctional apparatuses, which are apparatuses that form an image on a sheet used as a recording medium on the basis of image information input from an external personal computer (PC), image information read from a document, or the like. In addition, there is a case where a peripheral device such as an optional feeder, an image reading apparatus, or a sheet processing apparatus is coupled to a body having an image forming function, and the entire system in which the peripheral device is coupled to the body also serves as an image forming apparatus. In addition, examples of the sheet include paper such as paper sheets and envelopes, plastic films such as sheets for overhead projectors, and cloths.

As illustrated in FIGS. 1 and 2, the image forming apparatus 1 includes an apparatus body 1A having an opening portion 9, and a door 20 serving as an opening/closing member supported to be openable and closable between a closed position where the door 20 covers the opening portion 9 and an open position where the door 20 opens the opening portion 9 with respect to the apparatus body 1A. The door 20 is configured to be pivotable about a pivot shaft 20b. To be noted, the frame and exterior of the apparatus body 1A and the door 20 can be also collectively referred to as a main frame 10.

The apparatus body 1A accommodates an image forming unit 70 that forms an image on a sheet S, a feeding unit 30, a fixing unit 80, a discharge unit 130, and a moving unit 140 that will be described later. The image forming unit 70 includes a transfer unit 40, a tray unit 50 disposed above the transfer unit 40, and a scanner 2 disposed above the tray unit 50.

The tray unit 50 includes a tray 51 that can be drawn out from the apparatus body 1A, and four process cartridges PY, PM, PC, and PK that respectively form toner images of four colors of yellow (Y), magenta (M), cyan (C), and black (K). The four process cartridges PY, PM, PC, and PK are placed on the tray 51.

To be noted, the four process cartridges PY, PM, PC, and PK have the same configuration except for the color of the image formed thereby. Therefore, only the configuration and image forming process of the process cartridge PY will be described, and description of the process cartridges PM, PC, and PK will be omitted.

The process cartridge PY includes a photosensitive drum 61, a charging roller 62, and a developing roller 71. The photosensitive drum 61 is formed by applying an organic photoconductive layer on the outer peripheral surface of an aluminum cylinder, and is rotated by an unillustrated driving motor. The directions of the rotational axes of the photosensitive drum 61, the developing roller 71, and the charging roller 62 are parallel to each other.

The transfer unit 40 includes a driving roller 46, a tension roller 47, and an intermediate transfer belt 41 looped over the driving roller 46 and the tension roller 47. Primary transfer rollers 42Y, 42M, 42C, and 42K are provided on the inner peripheral side of the intermediate transfer belt 41. In addition, a secondary transfer roller 45 is provided to oppose the driving roller 46 with the intermediate transfer belt 41 therebetween, and the intermediate transfer belt 41 and the secondary transfer roller 45 form a transfer nip where an image is transferred onto the sheet S conveyed thereto. To be noted, an optical sensor 44 that detects a toner image transferred onto the intermediate transfer belt 41 is disposed in the image forming unit 70. The directions of the rotational axes of the primary transfer rollers 42Y, 42M, 42C, and 42K, the driving roller 46, the tension roller 47, and the secondary transfer roller 45 are parallel to each other.

The feeding unit 30 is provided in a lower portion of the image forming apparatus 1, and includes a cassette 31 that supports the sheet S, and a pickup roller 32 that feeds the sheet S supported by the cassette 31 serving as a supporting portion. The cassette 31 is configured to be attachable to and detachable from the apparatus body 1A on the same side as the opening portion 9. The discharge unit 130 includes a discharge roller pair 131 and a discharge tray If that supports the sheet S discharged by the discharge roller pair 131.

The fixing unit 80 includes a fixing portion 81 that fixes the toner image to the sheet by applying heat and pressure to the sheet, a guiding member 5, and a reverse conveyance roller pair 132. The fixing portion 81 includes a heating roller 83 including an unillustrated heater, and a pressurizing roller 84, and the heating roller 83 and the pressurizing roller 84 form a fixing nip that nips the sheet S. The guiding member 5 is configured to be pivotable to a discharge position indicated by a solid line in FIG. 2 and a reverse conveyance position indicated by a broken line in FIG. 2. The guiding member 5 guides the sheet S toward a discharge path 1d at the discharge position, and toward a reverse conveyance path le at the reverse conveyance position.

Next, an image forming operation of the image forming apparatus 1 configured in this manner will be described. The image forming apparatus 1 includes a controller 3 connected to an external host apparatus 110. The controller 3 controls, on the basis of an image signal received from the external host apparatus 110 or the reading unit, a scanner 2 to radiate laser light corresponding to the image signal onto the photosensitive drum 61 of the process cartridge PY. Examples of the external host apparatus 110 include personal computers, image readers, and facsimile machines.

At this time, the surface of the photosensitive drum 61 is uniformly charged to a predetermined polarity and potential by the charging roller 62, and an electrostatic latent image is formed thereon by the irradiation of the surface with the laser light from the scanner 2. The electrostatic latent image formed on the photosensitive drum 61 is developed by the developing roller 71, and a yellow (Y) toner image is formed on the photosensitive drum 61.

To be noted, the developing roller 71 is configured to be capable of coming into contact with and out of contact from the photosensitive drum 61. The lifetime of the photosensitive drum 61 and the developing roller 71 can be elongated by separating the developing roller 71 from the photosensitive drum 61 when the image forming apparatus 1 does not perform the image forming operation.

Similarly, the respective photosensitive drums of the process cartridges PM, PC, and PK are irradiated with laser light from the scanner 2, and thus magenta (M), cyan (C), and black (K) toner images are formed on the respective photosensitive drums. The toner images of the respective colors formed on the respective photosensitive drums are transferred onto the intermediate transfer belt 41 by the primary transfer rollers 42Y, 42M, 42C, and 42K, and are conveyed to a transfer nip by the intermediate transfer belt 41 rotated by the driving roller 46. To be noted, the image forming process of each color is performed at such a timing that each toner image formed by a process cartridge positioned more downstream is superimposed on a toner image that has been formed by a process cartridge positioned more upstream and that has been already transferred onto the intermediate transfer belt 41 through primary transfer. In addition, the residual toner remaining on the photosensitive drum 61 is removed by a cleaning blade.

In parallel with this image forming process, the sheet S accommodated in the cassette 31 of the feeding unit 30 is fed out to a conveyance path 1c by the pickup roller 32. Then, the skew of the sheet S is corrected by the registration roller pair 4 provided in the conveyance path 1c, and the sheet S is conveyed at a predetermined conveyance timing matching the transfer timing of the image at the transfer nip.

Then, the full-color toner image on the intermediate transfer belt 41 is transferred onto the sheet S at the transfer nip by a secondary transfer bias applied to the secondary transfer roller 45. In addition, the residual toner remaining on the intermediate transfer belt 41 is removed by a cleaning blade 43A provided in the cleaning portion 43. The sheet S onto which the toner image has been transferred is subjected to a predetermined heat and pressure applied by the heating roller 83 and the pressurizing roller 84 of the fixing unit 80, and thus toner is melted and adheres (is fixed) thereto. The sheet S having passed through the fixing unit 80 is guided to the discharge path 1d or the reverse conveyance path 1e by the guiding member 5.

When a simplex printing job for printing an image on only one surface is input, the guiding member 5 is positioned at a discharge position, and the sheet S is guided to the discharge path 1d. The sheet S guided to the discharge path 1d is discharged to the outside of the apparatus by the discharge roller pair 131, and is supported by the discharge tray 1f.

When a duplex printing job for forming an image on each surface of the sheet S is input, the sheet S on a first surface of which an image has been formed at the transfer nip is guided to the reverse conveyance path le by the guiding member 5 positioned at the reverse conveyance position. The reverse conveyance roller pair 132 provided in the reverse conveyance path le rotates in a reverse direction after the trailing end of the sheet S has passed the guiding member 5, and thus switches back the sheet S. In the meantime, the guiding member 5 moves to the discharge position, and the sheet S that has been switched back is guided to a duplex conveyance path 20a by the guiding member 5.

The sheet S guided to the duplex conveyance path 20a is conveyed to the conveyance path 1c by a plurality of conveyance roller pairs, and thus an image is formed on a second surface thereof at the transfer nip. Then, the toner image is fixed to the sheet S by the fixing unit 80 as described above, and then the sheet S is discharged onto the discharge tray If by the discharge roller pair 131.

In addition, as a result of the door 20 being opened from the closed position to the open position, the opening portion 9 is opened, and thus the conveyance path 1c and the duplex conveyance path 20a are exposed. As a result of this, the sheet S jammed in the conveyance path 1c or the duplex conveyance path 20a can be removed. In addition, the door 20 pivotably supports a secondary transfer frame supporting the secondary transfer roller 45. The duplex conveyance path 20a can be opened widely by pivoting the secondary transfer frame in a state in which the door 20 is positioned at the open position.

### Moving Unit

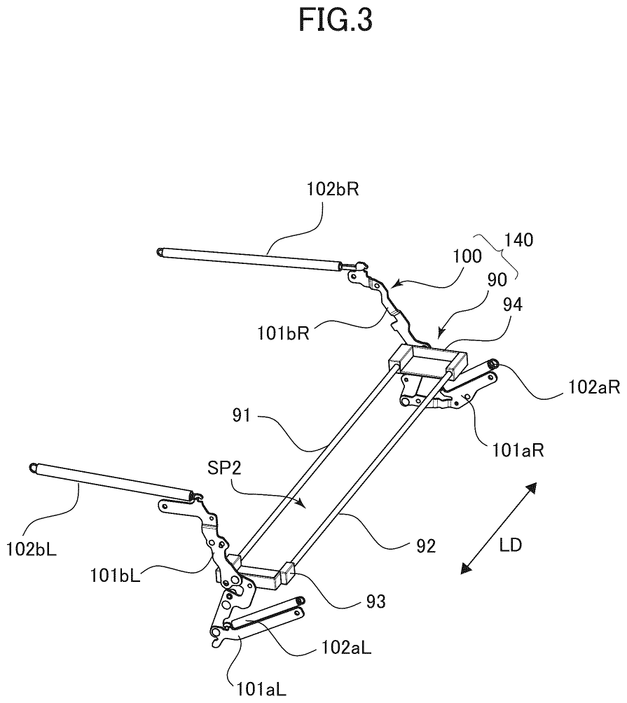

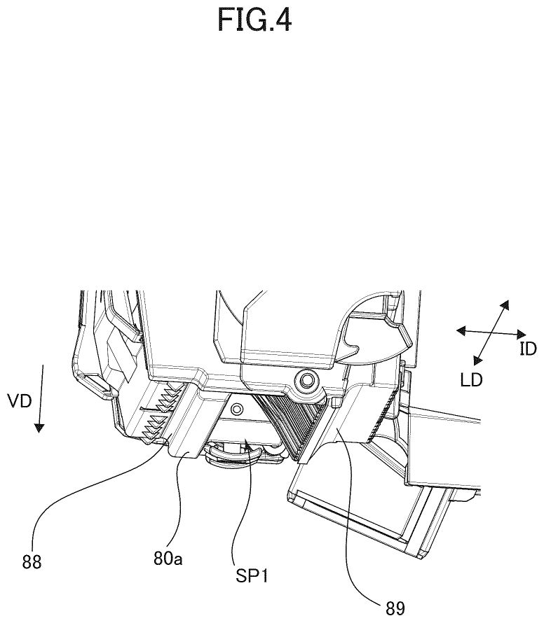

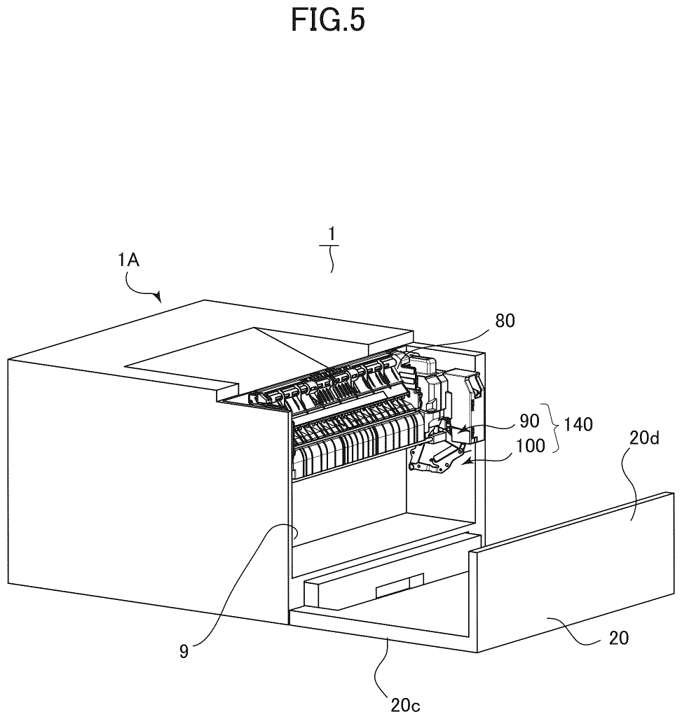

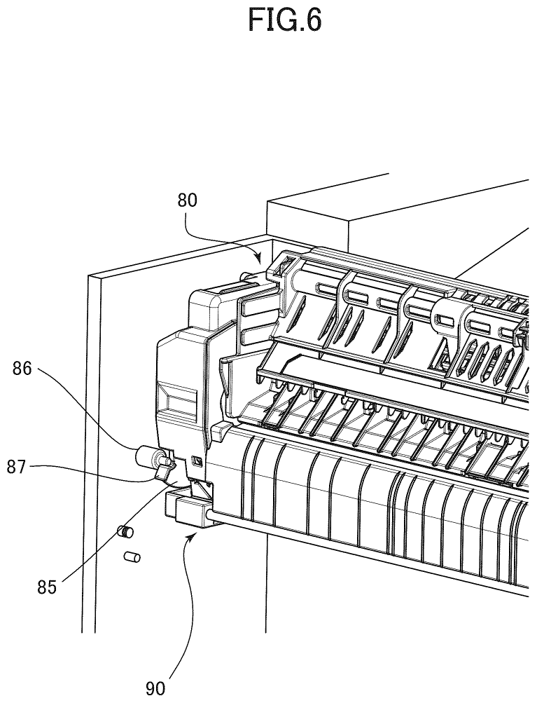

Next, the moving unit 140 will be described with reference to FIGS. 2 to 6. FIG. 3 is a perspective view of the moving unit 140. FIG. 4 is a perspective view of a lower surface 80a of the fixing unit 80. FIG. 5 is a perspective view of the image forming apparatus 1 in a state in which the door 20 is open. FIG. 6 is a perspective view of a fixing lock 85 and a locked portion 86.

The moving unit 140 is disposed between a right side plate and a left side plate that are not illustrated and that constitute part of the main frame 10, and includes a support portion 90 and a lifting/lowering portion 100 as illustrated in FIG. 3. The lifting/lowering portion 100 includes arms 101aL and 101bL that are disposed on one side in a longitudinal direction LD of the fixing unit 80, and urging members 102aL and 102bL that urge the arms 101aL and 101bL. To be noted, the longitudinal direction LD is a direction orthogonal to a vertical direction VD and parallel to the horizontal direction.

In addition, the lifting/lowering portion 100 includes arms 101aR and 101bR that are disposed on the other side in the longitudinal direction LD of the fixing unit 80, and urging members 102aR and 102bR that urge the arms 101aR and 101bR. One end portions of the arms 101aL, 101bL, 101aR, and 101bR are pivotably supported with respect to the apparatus body 1A. The arms 101aL and 101bL, and the arms 101aR and 101bR each constitute a link mechanism. To be noted, although the urging members 102aL, 102bL, 102aR, and 102bR are each constituted by a coil spring in the present embodiment, the configuration is not limited to this. For example, the urging members 102aL, 102bL, 102aR, and 102bR each may be constituted by a different spring such as a plate spring, and the urging members 102aL, 102bL, 102aR, and 102bR may be constituted by a plurality of kinds of springs.

The support portion 90 includes a pair of shaft members 91 and 92 extending in the longitudinal direction LD, and a pair of coupling members 93 and 94 coupling the respective end portions of the shaft members 91 and 92 in the longitudinal direction LD. Since the shaft members 91 and 92 are integrated via the coupling members 93 and 94, the stiffness of the support portion 90 can be improved. The support portion 90 is coupled to the lifting/lowering portion 100, and moves up and down together with the lifting/lowering portion 100. To be noted, the support portion 90 may be coupled to at least one pair of the arms 101aL and 101aR and the arms 101bL and 101bR of the lifting/lowering portion 100.

A pair of recess portions 88 and 89 corresponding to the pair of shaft members 91 and 92 are provided on the lower surface 80a of the fixing unit 80 as illustrated in FIG. 4. The recess portions 88 and 89 respectively engage with the shaft members 91 and 92 in a state in which the fixing unit 80 is supported by the support portion 90. When the recess portions 88 and 89 of the fixing unit 80 engage with the shaft members 91 and 92, the fixing unit 80 is positioned in an intersecting direction ID intersecting with both a vertical direction VD and the longitudinal direction LD. This is because the recess portion 88 engages with part of the outer peripheral surface of the shaft member 91 on the shaft member 92 side in the intersecting direction ID and the recess portion 89 engages with part of the outer peripheral surface of the shaft member 92 on the shaft member 91 side in the intersecting direction ID.

A space SP1 that the sheet S can pass through is provided between the recess portions 88 and 89. As illustrated in FIG. 3, the support portion 90 has an opening SP2 between the shaft members 91 and 92, and the sheet S is conveyed to the fixing nip through the opening SP2 and the space SP1 in a state in which the fixing unit 80 is supported by the support portion 90.

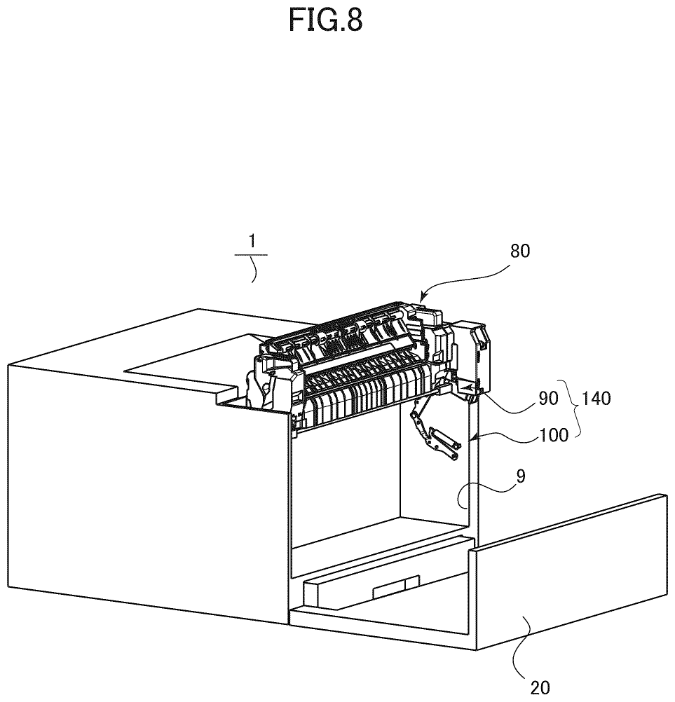

In a state in which the door 20 is positioned at the closed position, the fixing unit 80 is accommodated in the image forming apparatus 1 as illustrated in FIG. 2, and is positioned at a first position where the toner image can be fixed to the sheet S in the image forming operation. The moving unit 140 can move the fixing unit 80 to a second position illustrated in FIG. 8 in a state in which the fixing unit 80 is supported by the support portion 90. To be noted, at the first position, the fixing unit 80 is slightly away from the support portion 90 of the moving unit 140, and there is a minute gap between the fixing unit 80 and the pair of shaft members 91 and 92 of the support portion 90.

As illustrated in FIG. 5, when the door 20 is moved to the open position, the fixing unit 80 is exposed to the outside of the image forming apparatus 1 via the opening portion 9. Particularly, as illustrated in FIGS. 1 and 5, the door 20 includes a side surface 20c constituting one side surface of the image forming apparatus 1, and a top surface 20d constituting part of the top surface of the image forming apparatus 1, and is formed in an approximate L shape as a whole. That is, when the door 20 is moved to the open position, the space above the fixing unit 80 covered by the top surface 20d of the door 20 at the closed position is opened. Therefore, the fixing unit 80 can be moved up from the first position toward the second position. In other words, the movement of the fixing unit 80 from the first position to the second position is restricted in a state in which the door 20 is positioned at the closed position, and the movement of the fixing unit 80 from the first position to the second position is allowed in a state in which the door 20 is positioned at the open position. To be noted, in the present embodiment, the fixing unit 80 positioned at the first position does not overlap with the door 20 positioned at the closed position as viewed in the longitudinal direction LD, and the fixing unit 80 positioned at the second position at least partially overlaps with the door 20 positioned at the open position as viewed in the longitudinal direction LD.

Then, when the door 20 is opened from the closed position to the open position, the engagement between the door 20 and the moving unit 140 is cancelled. Then, the arms 101aL, 101bL, 101aR, and 101bR of the moving unit 140 are moved up by the urging force of the urging members 102aL, 102bL, 102aR, and 102bR serving as urging portions. The support portion 90 also moves up in an interlocked manner with the upward movement of the lifting/lowering portion 100. Then, the support portion 90 abuts the fixing unit 80 positioned at the first position, and then moves up the fixing unit 80 toward the second position.

The fixing unit 80 is provided with the fixing lock 85 as illustrated in FIG. 6, and when the upward movement of the fixing unit 80 is started, the fixing lock 85 engages with the locked portion 86 serving as a restricting portion provided in the apparatus body 1A. The fixing lock 85 is supported by a frame member of the fixing unit 80 so as to be movable between a restricting position and an allowing position, and is urged to the restricting position by an unillustrated urging member. The fixing lock 85 is capable of restricting the movement (move-up operation) of the fixing unit 80 from the first position to the second position by engaging with the locked portion 86 at the restricting position. In addition, at the allowing position, the engagement between the fixing lock 85 and the locked portion 86 is cancelled, and thus the movement (move-up operation) of the fixing unit 80 from the first position to the second position is allowed.

In a state in which the fixing lock 85 positioned at the restricting position and the locked portion 86 are engaged with each other, lifting of the fixing unit 80 from the support portion 90 is restricted. Therefore, the fixing unit 80 cannot be detached from the support portion 90.

To be noted, the fixing lock 85 and the locked portion 86 are provided on only one side of the image forming apparatus 1 in the longitudinal direction LD in the present embodiment, but may be provided on each side of the image forming apparatus 1 in the longitudinal direction LD.

### Attachment/Detachment Operation of Fixing Unit

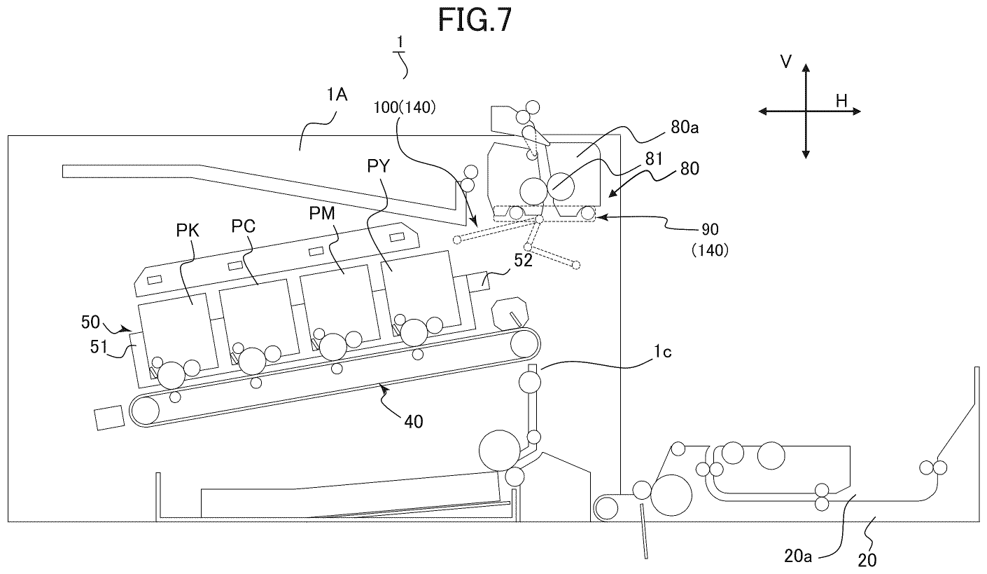

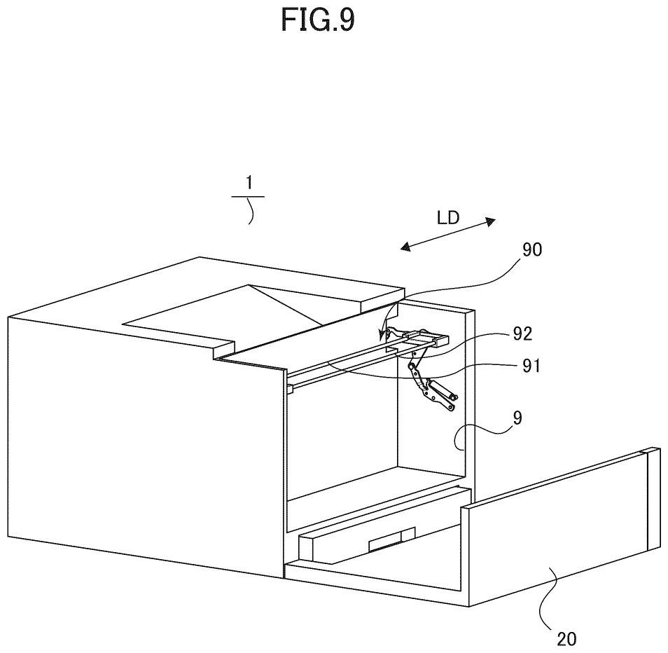

Next, the attachment/detachment operation of the fixing unit 80 will be described with reference to FIGS. 7 to 9. FIG. 7 is a section view of the image forming apparatus 1 in a state in which the door 20 is open. FIG. 8 is a perspective view of the fixing unit 80 positioned at the second position. FIG. 9 is a perspective view illustrating a state in which the fixing unit 80 is detached from the support portion 90.

First, a procedure of detaching the fixing unit 80 from the support portion 90 of the moving unit 140 will be described. As illustrated in FIG. 7, the user first moves the door 20 from the closed position to the open position. Then, the fixing unit 80 starts the move-up operation by the moving unit 140, but as illustrated in FIG. 6, the fixing lock 85 engages with the locked portion 86, and thus the move-up operation of the fixing unit 80 is restricted. For example, in the case of performing jam removal in the conveyance path 1c or the duplex conveyance path 20a, the user can perform the jam removal in the state of FIG. 7.

To detach the support portion 90 from the fixing unit 80, the user presses a pressing portion 87 of the fixing lock 85 illustrated in FIG. 6, and thus moves the fixing lock 85 from the restricting position to the allowing position. As a result of this, the move-up operation of the fixing unit 80 by the moving unit 140 is restarted, and the fixing unit 80 is lifted up to the second position as illustrated in FIG. 8. In this state, the user can detach the fixing unit 80 from the support portion 90 by lifting up the fixing unit 80. The fixing unit 80 is merely placed on the pair of shaft members 91 and 92 of the support portion 90, and therefore the fixing unit 80 can be easily detached from the support portion 90 by just lifting up the fixing unit 80.

In addition, in a state in which the moving unit 140 has moved up to the position of FIG. 8, the transfer unit 40 serving as an image forming portion for forming a toner image on the sheet and the tray unit 50 are attachable to and detachable from the apparatus body 1A via the opening portion 9. The transfer unit 40 and the tray unit 50 can be attached to and detached from the apparatus body 1A even in a state in which the fixing unit 80 is attached to the support portion 90 if the moving unit 140 has been moved up. That is, in a state in which the fixing unit 80 is positioned at the second position, the transfer unit 40 and the tray unit 50 are configured to be attachable to and detachable from the apparatus body 1A via the opening portion 9.

As described above, the fixing unit 80, the transfer unit 40, and the tray unit 50 are each configured to attachable to and detachable from the image forming apparatus 1 on the door 20 side. Therefore, when attaching or detaching the fixing unit 80, the transfer unit 40, and the tray unit 50, the image forming apparatus 1 can be accessed from one side, which improves the usability and reduces the installation space for installing the image forming apparatus 1. In addition, since the cassette 31 is also configured to be attachable to and detachable from the apparatus body 1A on the same side as the opening portion 9, the usability can be improved and the space can be reduced.

Meanwhile, the fixing unit 80 positioned at the first position overlaps with a movement trajectory of attachment and detachment of the transfer unit 40 and the tray unit 50 to and from the apparatus body 1A. Therefore, the image forming apparatus 1 can be miniaturized. To be noted, in the present embodiment, the transfer unit 40 and the tray unit 50 are configured to be attachable to and detachable from the apparatus body 1A independently from each other, but may be configured to be integrally attachable to and detachable from the apparatus body 1A.

In a state in which the support portion 90 is detached from the fixing unit 80, the support portion 90 is visually recognizable as illustrated in FIG. 9. In addition, the shaft members 91 and 92 of the support portion 90 extend in the longitudinal direction LD for the whole length of the fixing unit 80, and the user can intuitively recognize the position to place the fixing unit 80. Further, in the state in which the fixing unit 80 is detached from the support portion 90, since the moving unit 140 is maintained in the lifted-up state, the support portion 90 is positioned near the opening portion 9, and thus the visibility of the support portion 90 can be improved.

For example, when a consumable part of the fixing unit 80 has expired, the fixing unit 80 is replaced. When attaching a brand-new fixing unit 80 to the support portion 90, the fixing unit 80 is placed on the support portion 90 such that the shaft members 91 and 92 engage with the recess portions 88 and 89 provided in the lower surface 80a of the fixing unit 80. After the fixing unit 80 is attached to the support portion 90, the user pushes down the fixing unit 80 or the moving unit 140, and thus moves the fixing unit 80 down until movement of the fixing unit 80 is restricted by the locked portion 86. The user closes the door 20 in a state in which the fixing lock 85 provided on the fixing unit 80 is engaged with the locked portion 86.

When closing the door 20, the moving unit 140 is pushed down by an unillustrated pushing portion provided on the door 20. As a result of this, the fixing unit 80 is held at the first position in a state in which the fixing unit 80 is separated from the support portion 90 of the moving unit 140. To be noted, at the first position, the fixing unit 80 is held by at least one of the apparatus body 1A and the door 20. To be noted, the fixing unit 80 may be moved to the second position not only for replacement but also for, for example, removing the sheet S jammed in a state of being nipped by the fixing nip of the fixing unit 80.

As described above, the fixing unit 80 is configured to be attachable to and detachable from the support portion 90 of the moving unit 140 at the second position close to the opening portion 9. In addition, since the support portion 90 extends in the longitudinal direction LD and supports the fixing unit 80 from below, the fixing unit 80 can be detached from the support portion 90 by just lifting up the fixing unit 80, and thus the attachability and detachability of the fixing unit 80 can be improved.

Further, in a state in which the fixing unit 80 is detached from the support portion 90, the support portion 90 is positioned near the opening portion 9 and is visually recognizable. In addition, since the support portion 90 includes the shaft members 91 and 92 disposed parallel to each other, the user can intuitively recognize the position to attach the fixing unit 80, and thus the attachability and detachability of the fixing unit 80 can be improved.

In addition, when the fixing unit 80 is pushed down from the second position to the first position, the fixing lock 85 engages with the locked portion 86, and thus the fixing unit 80 is locked. Therefore, the user can intuitively determine to which position the fixing unit 80 should be pushed down. In addition, since the support portion 90 is formed in a rectangular shape from the pair of shaft members 91 and 92 and the pair of coupling members 93 and 94, the stiffness thereof can be improved. Therefore, when pushing down the fixing unit 80 from the second position toward the first position, the fixing unit 80 is stably supported so as to maintain the posture thereof without interference between the fixing unit 80 and the inner wall of the apparatus body 1A, and thus the attachability and detachability of the fixing unit 80 can be improved.

Further, even in the case where the door 20 is opened from the closed position to the open position, the fixing lock 85 engages with the locked portion 86, and thus the fixing unit 80 is held at a position close to the first position. That is, the fixing unit 80 is not automatically moved up to the second position by the moving unit 140 even if the door 20 is opened. Therefore, for example, in the case of performing jam removal in the conveyance path 1c or the duplex conveyance path 20a, the work of lifting or lowering the fixing unit 80 does not occur unless the fixing lock 85 is pressed, and thus the jam removability and usability can be improved.

### Second Embodiment

Next, a second embodiment of the present invention will be described. The second embodiment has a configuration in which the shape of the support portion 90 of the first embodiment is changed. Therefore, illustration of elements substantially the same as in the first embodiment will be omitted, or those elements are denoted by the same reference signs for description.

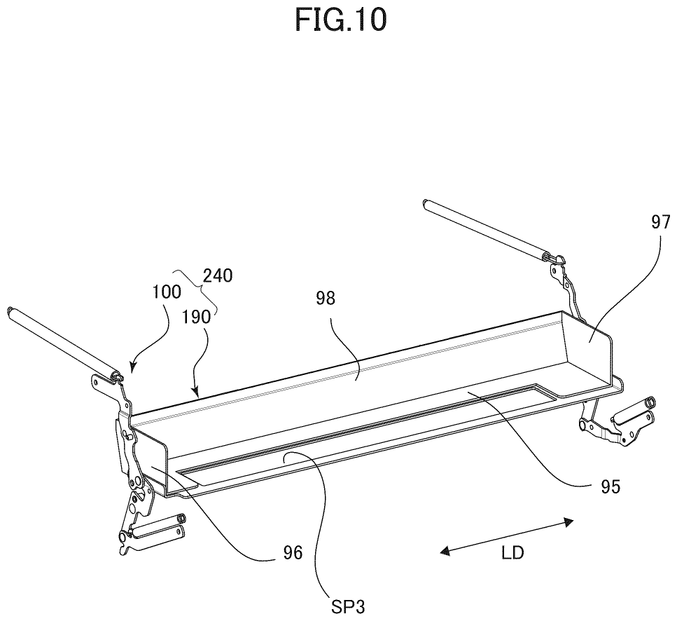

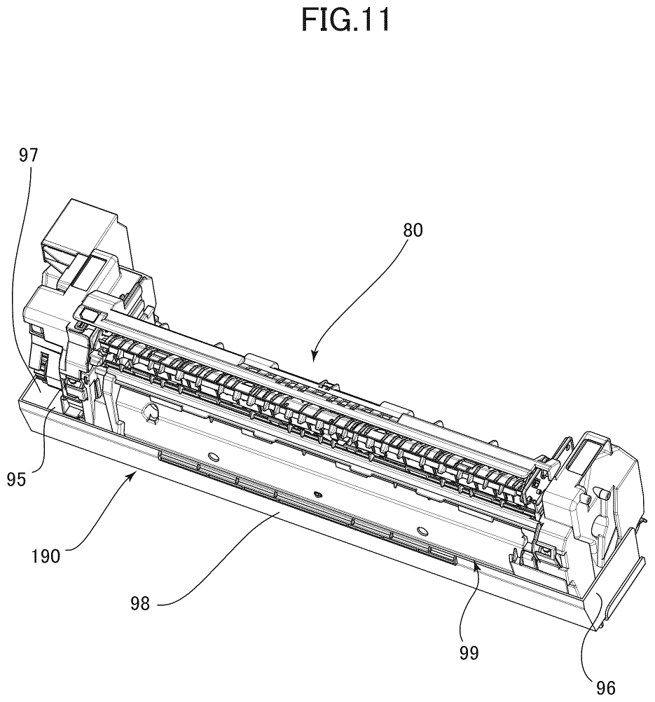

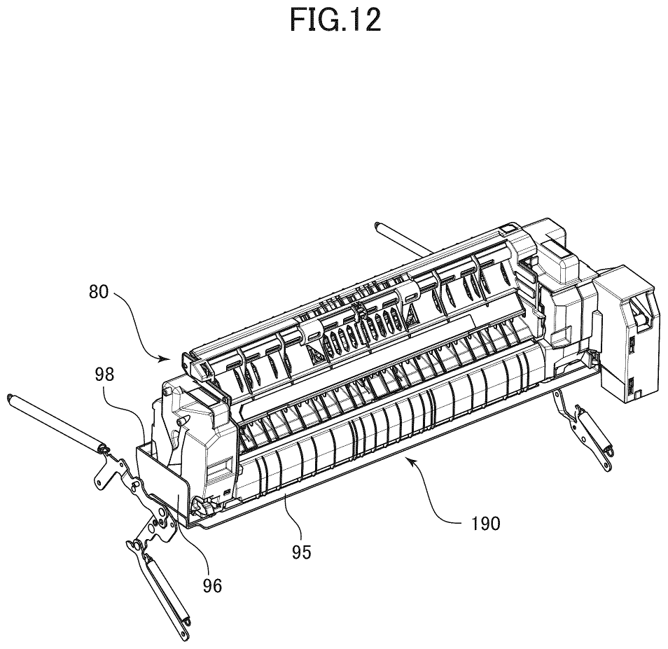

FIG. 10 is a perspective view of the moving unit 240 according to the second embodiment. FIG. 11 is a perspective view of a support portion 190 to which the fixing unit 80 is attached. FIG. 12 is another perspective view of the support portion 190 to which the fixing unit 80 is attached.

### Moving Unit

A moving unit 240 according to the present embodiment includes the support portion 190 and the lifting/lowering portion 100 as illustrated in FIG. 10. The lifting/lowering portion 100 has substantially the same configuration as in the first embodiment, and the support portion 190 is coupled to the lifting/lowering portion 100 to move in an interlocked manner with the lifting/lowering operation of the lifting/lowering portion 100.

The support portion 190 includes a placement surface 95 extending in the longitudinal direction LD and supporting the fixing unit 80 from below, and a pair of side surfaces 96 and 97 erecting upward from respective end portions of the placement surface 95 in the longitudinal direction LD. In addition, the support portion 190 includes a coupling surface 98 erecting upward from the placement surface 95 and coupling the pair of side surfaces 96 and 97. The pair of side surfaces 96 and 97 and the coupling surface 98 are provided to surround the fixing unit 80 in a state in which the fixing unit 80 is placed on the placement surface 95. An opening SP3 is provided in the placement surface 95, and the sheet S is conveyed to the fixing nip of the fixing unit 80 placed on the placement surface 95 through the opening SP3.

### Attachment/Detachment Operation of Fixing Unit

Next, the attachment/detachment operation of the fixing unit 80 to and from the support portion 190 will be described. Regarding the attachment/detachment operation of the fixing unit 80, the operation up to detachment of the fixing unit 80 is substantially the same as in the first embodiment. In a state in which the fixing unit 80 is detached from the support portion 190, the support portion 190 is visually recognizable as illustrated in FIG. 10. In addition, the placement surface 95 of the support portion 190 extends in the longitudinal direction LD for the whole length of the fixing unit 80, and the user can intuitively recognize the position to place the fixing unit 80. Further, the side surfaces 96 and 97 and the coupling surface 98 are arranged along the outer periphery of the fixing unit 80, and therefore the user can easily visually recognize the position to attach the fixing unit 80.

When attaching the fixing unit 80 to the support portion 190, the user aligns the side surfaces 96 and 97 with the exterior of the fixing unit 80, and simultaneously aligns the rear side of the fixing unit 80 with the coupling surface 98. In this state, the fixing unit 80 is placed on the placement surface 95 as illustrated in FIGS. 11 and 12.

As illustrated in FIG. 11, in a state in which the fixing unit 80 is placed on the placement surface 95, a gap 99 for air to flow through is secured between the fixing unit 80 and the coupling surface 98. When the image forming apparatus 1 performs the image forming operation, air blown by an unillustrated fan provided in the apparatus body 1A flows to the gap 99, and thus the transmission of heat from the fixing unit 80 to the support portion 190 can be reduced. As a result of this, when the user attaches and detaches the fixing unit 80 to and from the support portion 190, the support portion 190 reaching a high temperature can be suppressed, and the attachability and detachability of the fixing unit 80 can be improved.

### Other Embodiments

To be noted, although the support portion 90 includes the pair of shaft members 91 and 92 that engage with the recess portions 88 and 89 of the fixing unit 80 in the first embodiment, the configuration is not limited to this. The shape of the support portion 90 is not limited as long as the support portion 90 supports the fixing unit 80 from below. For example, the shaft members 91 and 92 of the support portion 90 are not limited to shapes having a circular cross-section, and may have a different shape such as a shape having a polygonal or elliptical cross-section. In addition, the number of the shaft members is not limited to two, and may be three or more. The recess portions provided in the fixing unit 80 may be provided in the same number as the shaft members. In addition, the support portion 90 may be provided with one or a plurality of protrusion portions or recess portions, and the fixing unit 80 may be provided with one or a plurality of recess portions or protrusion portions. In this case, the protrusion portions and the recess portions are engageable with each other. In addition, the fixing unit 80 may have recess portions that engage with the coupling members 93 and 94 of the support portion 90.

In addition, although the support portion 190 includes the placement surface 95, the side surfaces 96 and 97, and the coupling surface 98 in the second embodiment, the configuration is not limited to this. For example, for the support portion 190, either one of the coupling surface 98 and the side surfaces 96 and 97 may be omitted. In addition, the support portion 190 may include another coupling surface that is disposed on the opposite side to the coupling surface 98 across the fixing unit 80 and coupling the side surfaces 96 and 97.

In addition, although the second position of the fixing unit 80 is above the first position in any of the embodiments described above, the configuration is not limited to this. For example, the fixing unit 80 may be moved in the horizontal direction from the first position toward the second position, or may be moved obliquely downward.

In addition, although the lifting/lowering portion 100 includes a link mechanism constituted by a plurality of arms in any of the embodiments described above, the configuration is not limited to this. For example, the lifting/lowering portion 100 may include a rack portion, and the support portion 90 or 190 may be configured to be lifted and lowered via engagement between the rack portion and a pinion gear provided on the support portion 90 or 190. In addition, the support portion 90 or 190 may be provided with a pinion gear, and the lifting/lowering portion 100 may be provided with a rack portion. As described above, the configuration of the lifting/lowering portion 100 is not limited.

In addition, although the fixing unit 80 includes the heating roller 83 and the pressurizing roller 84 in any of the embodiments described above, the configuration is not limited to this. For example, a heating unit including a heater such as a ceramic heater and a fixing film heated by the heater may be used instead of the heating roller 83. In addition, a fixing belt including a heat generating layer that generates heat by induction heating may be used instead of the heating roller 83.

In addition, although the photosensitive drum 61, the charging roller 62, and the developing roller 71 are provided in each of the process cartridges (PY to PK) in any of the embodiments described above, the configuration is not limited to this. That is, the photosensitive drum 61, the charging roller 62, and the developing roller 71 may be provided in the process cartridge or the tray 51.

In addition, although the door 20 is provided to be pivotable about the pivot shaft 20b in any of the embodiments described above, the configuration is not limited to this. For example, a cover that is slidable or detachable with respect to the apparatus body 1A may be provided instead of the door 20.

In addition, although the opening SP2 is provided between the shaft members 91 and 92 in the first embodiment and the opening SP3 is provided in the placement surface 95 in the second embodiment, the shape of these openings is not limited. For example, these openings may be through holes or cutouts as long as the sheet S can pass therethrough.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-039388, filed Mar. 13, 2024, which is hereby incorporated by reference herein in its entirety.

What is claimed is:

1. An image forming apparatus configured to form a toner image on a sheet, the image forming apparatus comprising:
an apparatus body provided with an opening portion;
an opening/closing member supported to be openable and closable between an open position and a closed position with respect to the apparatus body, the opening/closing member covering the opening portion at the closed position and opening the opening portion at the open position;
a fixing unit supported to be attachable to and detachable from the apparatus body via the opening portion and configured to apply heat and pressure to the sheet to fix the toner image to the sheet; and
a moving unit provided in the apparatus body and configured to move the fixing unit from a first position toward a second position above the first position,
wherein movement of the fixing unit from the first position to the second position is restricted in a state in which the opening/closing member is positioned at the closed position and is allowed in a state in which the opening/closing member is positioned at the open position,
wherein the moving unit includes a support portion configured to support the fixing unit positioned at the second position such that the fixing unit is attachable and detachable, and
wherein the support portion extends in a longitudinal direction of the fixing unit and supports the fixing unit from below.

2. The image forming apparatus according to claim 1, wherein the fixing unit positioned at the first position does not overlap with the opening/closing member positioned at the closed position when viewed in the longitudinal direction, and
wherein at least a part of the second position of the fixing unit overlaps with the opening/closing member positioned at the closed position when viewed in the longitudinal direction.

3. The image forming apparatus according to claim 1, wherein the support portion includes a pair of shaft members extending in the longitudinal direction, and
wherein a lower surface of the fixing unit is provided with a pair of recess portions configured to engage with the pair of shaft members.

4. The image forming apparatus according to claim 3, wherein the support portion includes a pair of coupling members configured to couple respective end portions of the pair of shaft members in the longitudinal direction to each other.

5. The image forming apparatus according to claim 1, wherein the support portion includes a placement surface extending in the longitudinal direction on which the fixing unit is placed, a pair of side surfaces erecting upward from respective end portions, in the longitudinal direction, of the placement surface, and a coupling surface erecting upward from the placement surface to couple the pair of side surfaces.

6. The image forming apparatus according to claim 5, wherein in a state in which the fixing unit is placed on the placement surface, the fixing unit is provided with a gap, between the fixing unit and the coupling surface, through which air flows.

7. The image forming apparatus according to claim 1, wherein the support portion is provided with an opening that the sheet conveyed toward the fixing unit positioned at the first position is capable of passing through.

8. The image forming apparatus according to claim 1, wherein the moving unit includes an urging portion configured to urge the fixing unit from the first position toward the second position.

9. The image forming apparatus according to claim 1, further comprising a restricting portion configured to restrict the movement of the fixing unit from the first position to the second position.

10. The image forming apparatus according to claim 9, wherein the fixing unit includes an engagement portion configured to move to a restricting position where the engagement portion engages with the restricting portion to restrict the movement of the fixing unit from the first position to the second position, and an allowing position where engagement between the restricting portion and the engagement portion is released to allow the movement of the fixing unit from the first position to the second position.

11. The image forming apparatus according to claim 10, wherein the fixing unit is moved to the second position by the moving unit in a case where the opening/closing member is moved from the closed position to the open position and the restricting portion is moved from the restricting position to the allowing position.

12. The image forming apparatus according to claim 1, wherein the support portion of the moving unit is separated from the fixing unit positioned at the first position in a case where the opening/closing member is positioned at the closed position.

13. The image forming apparatus according to claim 1, further comprising an image forming portion configured to form the toner image on the sheet,
wherein the image forming portion is configured to be attachable to and detachable from the apparatus body through the opening portion in a state in which the fixing unit has been moved to the second position by the moving unit.

14. The image forming apparatus according to claim 13, wherein the fixing unit positioned at the first position overlaps with a movement trajectory of attachment and detachment of the image forming portion to and from the apparatus body.

15. The image forming apparatus according to claim 1, further comprising a supporting portion configured to support the sheet fed toward the fixing unit,
wherein the supporting portion is configured to be attachable to and detachable from the apparatus body on the same side as the opening portion.
